(19) United States
(12) Patent Application Publication
(10) Pub. No.: US 2011/0180644 A1
(43) Pub. Date: Jul. 28, 2011

(54) FOOD MINCER

(76) Inventor: Robert Radi, La Quinta, CA (US)

(21) Appl. No.: 13/014,642

(22) Filed: Jan. 26, 2011

Related U.S. Application Data
(60) Provisional application No. 61/298,846, filed on Jan. 27, 2010.

(51) Int. Cl. B02C 17/20

(52) U.S. Cl. 241/277

(57) ABSTRACT

The present invention provides, in at least one embodiment, a food mincer with blades that are not exposed, simple activation by pressing the actuator down, a transparent bottom vessel allowing the food preparer to see the food while it is being minced, dual rotating blades which rotate around the vertical axis and the horizontal axis, and blades interdisposed for better cuts.

### CROSS REFERENCE TO RELATED APPLICATIONS

This application claims priority under 35 U.S.C. §119(e) to U.S. Provisional Application No. 61/298,846, filed Jan. 27, 2010, and entitled “MOTORIZED FOOD MINCER,” the disclosure of which is hereby incorporated by reference in its entirety.

### BACKGROUND OF THE INVENTION

1. Field of Invention

The present invention relates generally to mincing and more particularly to a food mincer.

2. Description of Related Art

Mincing is a cooking technique in which food ingredients are finely divided. The effect is to create a closely bonded mixture of ingredients and a soft or pasty texture. Flavoring ingredients such as garlic, ginger, and fresh herbs may be minced to distribute flavor more evenly in a mixture. Additionally, bruising of the tissue can release juices and oils to deliver flavors uniformly in a sauce.

A food mincer is a kitchen appliance for grinding, fine mincing, or mixing raw or cooked meat, fish, vegetables or similar food. It replaces tools like the mincing knife, for example, which has been used to produce minced meat.

When preparing certain foods, it is sometimes necessary to utilize a food mincer to mince a food item. For instance, when preparing an onion for use in various recipes, it is often necessary to cut the onion into small pieces, a process sometimes referred to as mincing. Additionally, many herbs, nuts, and cooked meats are also minced prior to being used in a recipe. While it is possible to use a knife to mince a food product, it is often simpler to use a mincer to mince a food product. A mincer often includes a plurality of blades that are spaced apart to allow the food to be cut into small pieces by rolling the blades over the food.

However, past mincers have also had inherent shortcomings. For example, some past mincers have left the blades exposed, increasing the likelihood of a user being inadvertently cut by the mincer. Other conventional mincers do not offer the simplicity to the food preparer, such as a simple activation and the ability to view the food as it is being minced such that the preparer can accurately determine when to stop mincing. Further, conventional mincers lack dual rotation blades which rotate around the vertical axis and the horizontal axis and interdisposed blades for better cuts.

U.S. Pat. No. 7,637,445 describes a food cutting device for cutting food items into smaller pieces, comprising a receptacle having an entrance through which food items can be introduced into the receptacle and an exit through which smaller pieces of the food items can be dispensed from the receptacle, a rotary cutter in the receptacle for cutting the food items into the smaller pieces, and a handle connected with the receptacle, for holding and carrying the food cutting device with only one hand of a user.

U.S. Pat. No. 4,153,208 describes a cutter set for use in a mincing machine for grinding up of food, particularly meat, cheese and fat. The food is supplied to the cutter set by a conveyor screw. The cutter set consists of at least one rotating knife and at least one perforated disk. The rotating knife has an annular channel around the periphery thereof for facilitating a discharge of hard particles contained in the food.

Conventional food mincers lack many useful features that improve the mincing experience, such as safer enclosed blades, simple activation and viewing, and better cuts.

### SUMMARY OF THE INVENTION

The present invention overcomes these and other disadvantages of the prior art by providing, in at least one embodiment, a food mincer with blades that are not exposed, simple activation by pressing the actuator down, a transparent bottom vessel allowing the food preparer to see the food while it is being minced, dual rotating blades which rotate around the vertical axis and the horizontal axis, and blades interdisposed for better cuts.

In an embodiment of the invention, a device comprises: a housing; a bottom vessel attached to the housing, the bottom vessel configured to hold cut food and uncut food, the bottom vessel being transparent so that the amount of cut food and uncut food in the bottom vessel is visible; one or more blades covered by the bottom vessel, the blades configured to cut food; and an actuator coupled to the blades, the blades activated by the actuator moving from a first position to a second position, wherein the blades rotate around a horizontal axis and around a vertical axis. The blades may comprise a first blade set and a second blade set, wherein the first blade set is interdisposed within the second blade set. The first blade set may spin and the second blade set may be fixed, or both blade sets may spin. The actuator may comprise manual and motorized operations. The actuator may be activated by manually pushing the actuator vertically downward from the first position to the second position.

In another embodiment, a device comprises: a housing; one or more blades covered by the housing, the blades configured to cut food, wherein the blades comprise a first blade set and a second blade set, wherein the first blade set is interdisposed within the second blade set; and an actuator coupled to the blades, the blades activated by the actuator moving from a first position to a second position, wherein the blades rotate around a vertical axis. The device may further comprise a bottom vessel attached to the housing, the bottom vessel configured to hold cut food and uncut food, the bottom vessel transparent so that the amount of cut food and uncut food in the bottom vessel is visible. The blades may rotate around a horizontal axis. The blades may comprise a first blade set and a second blade set, wherein the first blade set is interdisposed within the second blade set. The first blade set may spin and the second blade set may be fixed, or both blade sets may spin. The actuator may comprise manual and motorized operations. The actuator may be activated by manually pushing the actuator vertically downward from the first position to the second position.

In another embodiment, a device comprises: a housing; one or more blades covered by the housing, the blades configured to cut food, wherein the blades comprise a first blade set and a second blade set, wherein the first blade set is interdisposed within the second blade set; and a motorized actuator coupled to the blades, wherein the actuator is activated by manually pushing the actuator vertically downward from the first position to the second position, wherein the blades rotate around a vertical axis. The device may further comprise a bottom vessel attached to the housing, the bottom vessel configured to hold cut food and uncut food, the bottom vessel transparent so that the amount of cut food and uncut food in the bottom vessel is visible. The blades may rotate around a horizontal axis. The blades may comprise a first blade set and a second blade set, wherein the first blade set is interdisposed within the second blade set. The first blade set may spin and the second blade set may be fixed, or both blade sets may spin.

Embodiments of the present invention have several advantages over existing technology. For example, the enclosed blades make the food mincer safer. The food mincer makes mincing much simpler, with the cut and uncut food being visible, simple activation, and a motorized option. The dual rotating blades and alternative blade configuration provide better cuts. Additionally, advantages of the present invention include convenient and efficient mincing of food ingredients to create, for example, fresh dressings and marinades. Mincing can performed in a motorized manner without the need for manual power. Further, the food mincer advantageously creates even mincing of produce, simulates knife mincing, and does not turn minced food into paste like if put in a blender.

The foregoing, and other features and advantages of the invention will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a mincer according to an embodiment of the invention;

FIG. 2 illustrates the mincer of FIG. 1 in operation; and

FIGS. 3 and 4 illustrate mincing blades according to an alternative embodiment of the invention.

### DETAILED DESCRIPTION OF EMBODIMENTS

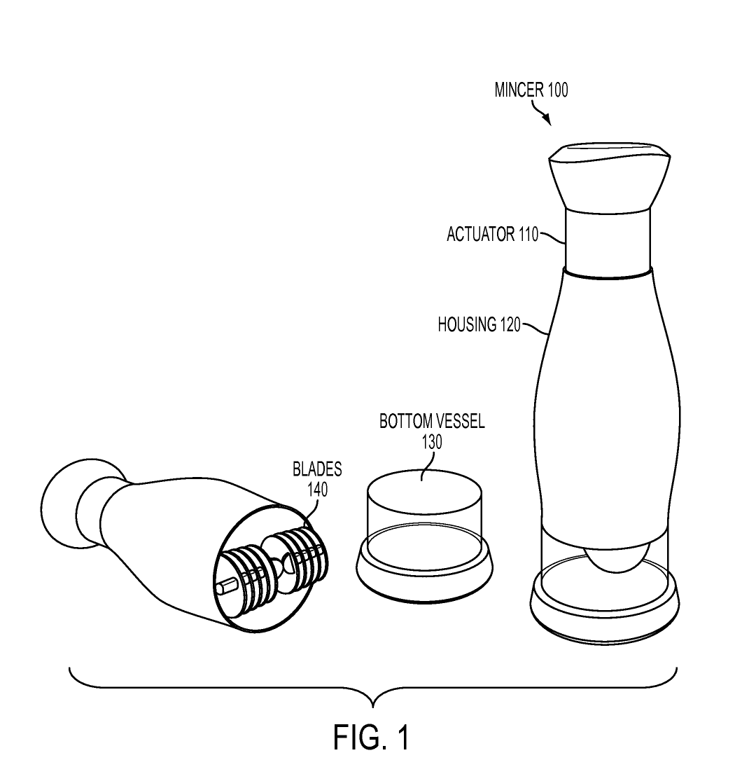

Further features and advantages of the invention, as well as the structure and operation of various embodiments of the invention, are described in detail below with reference to the accompanying FIGS. 1-4, wherein like reference numerals refer to like elements. Although embodiments of the invention are described in the context of a particular type of food being minced, one of ordinary skill in the art readily appreciates that the present invention is applicable to other food that can be minced with a knife, such as a produce, flavoring ingredients, meat, and vegetables.

The present invention overcomes these and other disadvantages of the prior art by providing, in at least one embodiment, a food mincer with blades that are not exposed, simple activation, a transparent bottom vessel giving the food preparer the ability to see the food while it is being minced, dual rotating blades, and blades interdisposed for better cuts. The present invention provides a motorized food mincer to mince food into very small parts, or into ingredients. In an embodiment of the invention, the mincer is powered by a 12 volt transformer and features ten rolling stainless steel blades when the motor is engaged. A bottom vessel provides a receptacle where the food is placed, then minced, and stored after mincing. The bottom vessel also provides a stable base for the mincer. As a safety precaution, the bottom vessel must be in place for the mincer to operate.

FIG. 1 illustrates a mincer 100 according to an embodiment of the invention. The mincer 100 may be motorized or manual. The mincer 100 comprises an actuator 110, a housing 120, a bottom vessel 130, and mincing blades 140. The actuator 110 is located at one end of the housing 120. The bottom vessel 130 is located at the other end of the housing 120. The housing 120 houses a motor (not shown) for powering the mincing blades 140. Although the actuator 110 is shown at the top of the housing 120, one of ordinary skill in the art appreciates that such a configuration is exemplary only and that other configurations may be implemented. For example, the actuator may be located on a side of the housing 120. The bottom vessel 130 is configured to be attached and detached from the housing 120. As a safety feature, the motor will not engage and the blades 140 will not rotate until the bottom vessel 130 is secured to the housing 120. The housing 120 may be constructed from a durable and corrosion resistant material such as stainless steel or plastic, however such materials are exemplary only. The bottom vessel 130 may be constructed of a plastic for easy washing. The size of the mincer 100 can be in line with manual choppers currently on the market, which is approximately 3-4 inches in diameter and 7-8 inches tall. The bottom vessel 130 should be large enough such that multiple refills are needed to cut the desired amount of food, but small enough such that the food mincer can easily be stored in a kitchen.

In an exemplary embodiment of the invention, the blades 140 comprise a set of ten circular blades, which rotate about a common horizontal axis. The rotation of the blades 140 is driven by an internal motor. The blades 140 are preferably constructed from a durable and corrosion resistant material such as stainless steel and are easy to wash. The blades can be removable for ease of cleaning. The blades 140 may have a sharp knife-like edge to enhance mincing.

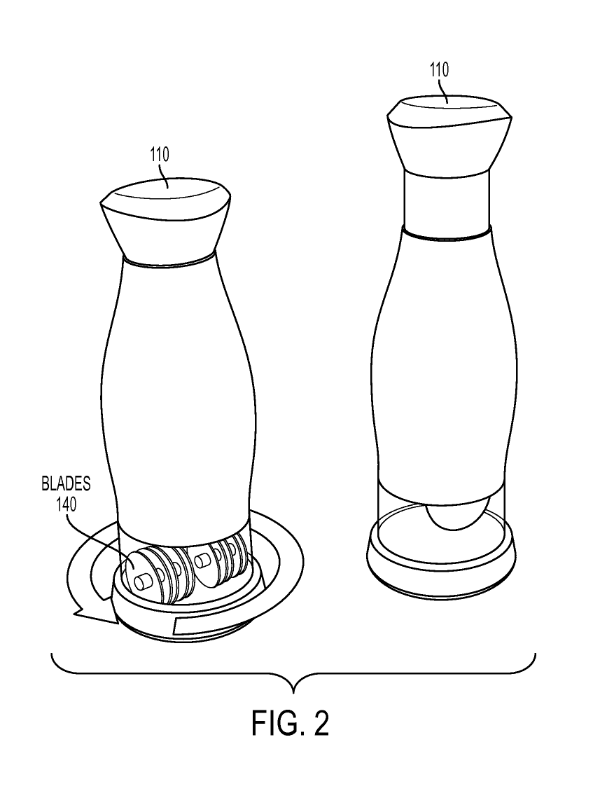

FIG. 2 illustrates the mincer 100 in operation with the actuator turned on (left) and turned off (right). On the left side, the actuator 110 has been pressed down, i.e., activated, thereby powering the blades 140. In addition to rotating about a common horizontal axis, the blades 140 also rotate about a vertical axis as shown by the circular arrow around the vertical axis. This dual rotation configuration greatly enhances mincing. Although not shown, ingredients are placed into the bottom vessel 130. Exemplary ingredients include herbs, spices, oil, and vinegars. One of ordinary skill in the art recognizes that any food ingredient that can be minced can be placed in the bottom vessel 130.

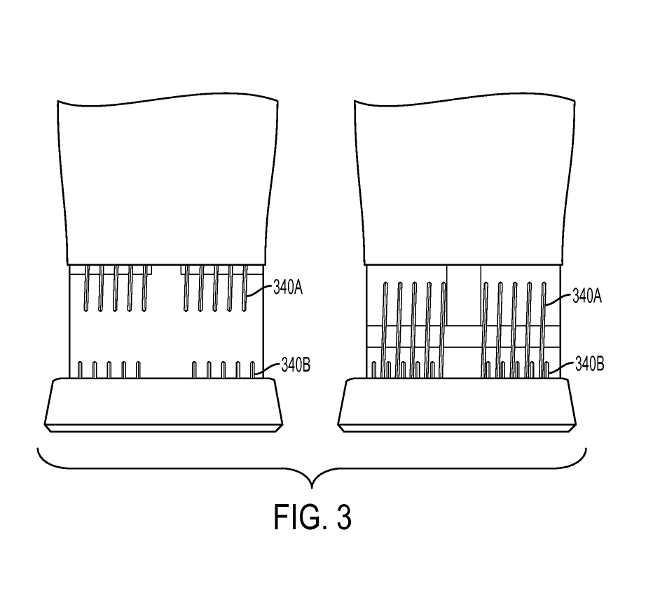

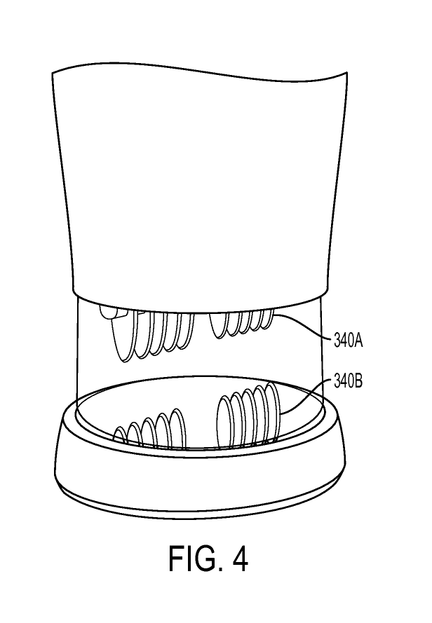

FIGS. 3 and 4 illustrate blades 340A and 340B according to an alternative embodiment of the invention. In this configuration, a set of ten blades 340A are driven by an internal motor and are able to rotate about a common horizontal axis. Another set of ten blades 340B are fixed at the bottom of the bottom vessel 130. The left side of FIG. 3 shows blades 340A and 340B disengaged from one another in a non-operative state, i.e., the actuator 110 has not been activated. The right side of FIG. 3 shows the blades 340A and 340B engaged with one another in an operative state, i.e., the actuator 110 has been engaged. In operation, the blades 340A travel downward and are interdisposed between the blades 340B to enhance mincing. Here, the blades 340A may further rotate about a vertical axis as well. FIG. 4 is another angle for this alternative blade configuration, where the top blade set spins about the center of the unit and the bottom blade set is fixed.

In an alternative embodiment of the invention, the motor is replaced with a simple gear mechanism, the implementation of which is apparent to one of ordinary skill in the art that is activated by manual up and down motion to drive the rotation of the blades 140 or 340A. In the manual embodiment, the blades can spin in both directions. For example, when the actuator is pressed down the blade spins in one direction, but when the actuator is lifted up, the blade spins in the opposite direction. Also, in the manual embodiment, the harder the food preparer pushes down on the actuator, the stronger the cut will be.

In the motorized embodiment, the motor may be battery operated or powered by a transformer coupled to an electrical wall socket. The mincer 100 may be powered by 12 volts.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A device comprising:
a housing;
a bottom vessel attached to the housing, the bottom vessel configured to hold cut food and uncut food, the bottom vessel being transparent so that the amount of cut food and uncut food in the bottom vessel is visible;
one or more blades covered by the bottom vessel, the blades configured to cut food; and
an actuator coupled to the blades, the blades activated by the actuator moving from a first position to a second position, wherein the blades rotate around a horizontal axis and around a vertical axis.

2. The device of claim 1, wherein the blades comprise a first blade set and a second blade set, wherein the first blade set is interdisposed within the second blade set.

3. The device of claim 2, wherein the first blade set spins and the second blade set is fixed.

4. The device of claim 2, wherein both the first blade set and the second blade set spin.

5. The device of claim 1, wherein the actuator comprises manual and motorized operations.

6. The device of claim 1, wherein the actuator is activated by manually pushing the actuator vertically downward from the first position to the second position.

7. A device comprising:
a housing;
one or more blades covered by the housing, the blades configured to cut food, wherein the blades comprise a first blade set and a second blade set, wherein the first blade set is interdisposed within the second blade set; and
an actuator coupled to the blades, the blades activated by the actuator moving from a first position to a second position, wherein the blades rotate around a vertical axis.

8. The device of claim 7, further comprising a bottom vessel attached to the housing, the bottom vessel configured to hold cut food and uncut food, the bottom vessel transparent so that the amount of cut food and uncut food in the bottom vessel is visible.

9. The device of claim 7, wherein the blades rotate around a horizontal axis.

10. The device of claim 7, wherein the first blade set spins and the second blade set is fixed.

11. The device of claim 7, wherein both the first blade set and the second blade set spin.

12. The device of claim 7, wherein the actuator comprises manual and motorized operations.

13. The device of claim 7, wherein the actuator is activated by manually pushing the actuator vertically downward from the first position to the second position.

14. A device comprising:
a housing;
one or more blades covered by the housing, the blades configured to cut food, wherein the blades comprise a first blade set and a second blade set, wherein the first blade set is interdisposed within the second blade set; and
a motorized actuator coupled to the blades, wherein the actuator is activated by manually pushing the actuator vertically downward from the first position to the second position, wherein the blades rotate around a vertical axis.

15. The device of claim 14, further comprising a bottom vessel attached to the housing, the bottom vessel configured to hold cut food and uncut food, the bottom vessel transparent so that the amount of cut food and uncut food in the bottom vessel is visible.

16. The device of claim 14, wherein the blades rotate around a horizontal axis.

17. The device of claim 14, wherein the first blade set spins and the second blade set is fixed.

18. The device of claim 14, wherein both the first blade set and the second blade set spin.
